(19) United States
(12) Patent Application Publication
(10) Pub. No.: US 2026/0024855 A1
(43) Pub. Date: Jan. 22, 2026

(54) BATTERY CELL INCLUDING ELECTRODE TAB, BATTERY MODULE INCLUDING THE SAME, AND BATTERY CELL MANUFACTURING METHOD

(71) Applicant: SK On Co., Ltd., Seoul (KR)

(72) Inventors: Ho Jin HWANG, Daejeon (KR); Gyu Sik KIM, Daejeon (KR); Young Ha KIM, Daejeon (KR); Sung Hee MIN, Daejeon (KR); Ga Yeong YOO, Daejeon (KR); Min Jae LEE, Daejeon (KR)

(21) Appl. No.: 19/267,661

(22) Filed: Jul. 14, 2025

(30) Foreign Application Priority Data
Jul. 22, 2024 (KR) 10-2024-0096670

(51) Int. Cl. H01M 50/178; H01M 50/105; H01M 50/211; H01M 50/507

(52) U.S. Cl. CPC H01M 50/178; H01M 50/105; H01M 50/211; H01M 50/507

(57) ABSTRACT

A battery cell includes an electrode assembly, a pouch including an electrode accommodating portion accommodating the electrode assembly and a sealing portion surrounding at least a portion of the electrode accommodating portion, and an electrode tab electrically connected to the electrode assembly and located inside the pouch. The pouch may include a through-hole formed in the sealing portion, and the electrode tab may be exposed to the outside of the pouch through the through-hole.

### CROSS-REFERENCE TO RELATED APPLICATIONS

This patent document claims the priority and benefits of Korean Patent Application No. 10-2024-0096670 filed on Jul. 22, 2024, the disclosure of which is incorporated herein by reference in its entirety.

### TECHNICAL FIELD

The disclosure and implementations disclosed in this patent document generally relate to a battery cell including an electrode tab, a battery module including the same, and a method of manufacturing a battery cell.

### BACKGROUND

Unlike primary batteries, secondary batteries may be charged with and discharged of electricity, and thus may be applied to devices within various fields, such as digital cameras, mobile phones, laptops, hybrid vehicles, electric vehicles, and energy storage systems (ESS). Secondary batteries may include a lithium-ion battery, a nickel-cadmium battery, a nickel-metal hydride battery, or a nickel-hydrogen battery.

Secondary batteries have been manufactured as flexible pouch-type battery cells or rigid prismatic or cylindrical can-type battery cells. A cell assembly of a plurality of battery cells may be disposed in a module housing to form a battery module.

### SUMMARY

A battery cell may include an electrode assembly, a pouch, and an electrode tab. The electrode tab may extend to the outside of the pouch and may be electrically connected to an external component (e.g., a busbar) of the battery cell. However, the size of the electrode assembly may be limited due to the space occupied by the electrode tab extending to the outside of the pouch, and dead space may occur in the battery module.

The present disclosure may be implemented in some embodiments to provide a battery cell or battery module with reduced dead space and improved energy density may be provided.

The battery cell and battery module of the present disclosure may be widely applied to electric vehicles, battery charging stations, and green technology fields, such as solar power generation and wind power generation using batteries. In addition, the battery cell and battery module of the present disclosure may be used in eco-friendly electric vehicles and hybrid vehicles to ameliorate the effects of climate change by suppressing air pollution and greenhouse gas emissions.

In some embodiments of the present disclosure, a battery cell includes: an electrode assembly; a pouch including an electrode accommodating portion accommodating the electrode assembly and a sealing portion surrounding at least a portion of the electrode accommodating portion; and an electrode tab electrically connected to the electrode assembly and located inside the pouch. The pouch may include a through-hole formed in the sealing portion, and the electrode tab may be exposed to the outside of the pouch through the through-hole.

The electrode tab may be located within the sealing portion.

The electrode tab may include an upper surface, a rear surface opposite to the upper surface, and a side surface located between the upper surface and the rear surface. The side surface may be covered by the pouch.

The through-hole may include a first recess facing the upper surface and a second recess facing the rear surface.

The electrode tab may include a first region located between the first recess and the second recess and at least partially exposed to the outside of the through-hole and a second region extending from the first region and bonded to a current collector of the electrode assembly.

The electrode tab may include an upper surface, a rear surface opposite to the upper surface, and a side surface located between the upper surface and the rear surface. The through-hole may include a third recess facing at least a portion of the side surface and penetrating through upper and lower portions of the sealing portion.

The battery cell may further include a sealant sealing a gap between the electrode tab and the sealing portion.

In some embodiments of the present disclosure, a battery module includes: a cell assembly including a plurality of battery cells; and a busbar electrically connecting the plurality of battery cells. The plurality of battery cells may respectively include: an electrode assembly; a pouch including electrode accommodating portion accommodating the electrode assembly and a sealing portion surrounding at least a portion of the electrode accommodating portion; and an electrode tab electrically connected to the electrode assembly and located inside the pouch. The pouch may include a through-hole formed in the sealing portion, and the electrode tab may be exposed to the outside of the pouch through the through-hole.

The electrode tab may include an upper surface, a rear surface opposite to the upper surface, and a side surface located between the upper surface and the rear surface, and the side surface may be covered by the pouch.

The busbar may include a plurality of conductive blocks respectively located between the electrode tabs of the plurality of battery cells.

The electrode tab may include an upper surface, a rear surface opposite to the upper surface, and a side surface located between the upper surface and the rear surface, the side surface may be covered by the pouch. The upper surface and the rear surface may be in contact with the plurality of conductive blocks.

The through-hole may include a first recess facing the upper surface and a second recess facing the rear surface. Each of the plurality of conductive blocks may have at least a portion located within the first recess and the second recess.

The electrode tab may include an upper surface, a rear surface opposite to the upper surface, and a side surface located between the upper surface and the rear surface. The through-hole may include a third recess facing at least a portion of the side surface and penetrating through upper and lower portions of the sealing portion. The busbar may pass through the third recess of the plurality of battery cells and electrically connect the electrode tabs of the plurality of battery cells.

In some embodiments of the present disclosure, a method of manufacturing a battery cell includes: a punching process of forming a through-hole in a pouch; a placement process of disposing an electrode assembly to which an electrode tab may be connected in the pouch so that at least a portion of the electrode tab faces the through-hole; and a sealing process of forming a sealing portion surrounding at least a portion of the electrode tab.

The sealing process may be a process of pressing the pouch so that the sealing portion covers at least a portion of the electrode tab while at least a portion of the electrode tab faces the through-hole.

The electrode tab may include an upper surface, a rear surface opposite to the upper surface, and a side surface located between the upper surface and the rear surface. The placement process may be a process of allowing the upper surface to face a first recess of the through-hole and the rear surface to face a second recess of the through-hole.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment;

FIG. 2 is a cross-sectional view of a battery cell according to an embodiment;

FIG. 3 is a top view of a battery cell according to an embodiment;

FIG. 4 is a perspective view of an electrode tab on which a sealant is disposed according to an embodiment;

FIG. 5 is a perspective view of a battery module according to an embodiment;

FIG. 6 is a perspective view of a battery cell according to another embodiment;

FIG. 7 is a perspective view of a battery module according to another embodiment;

FIGS. 8 and 9 are diagrams illustrating a method of manufacturing a battery cell according to an embodiment; and

FIG. 10 is a flowchart of a method of manufacturing a battery cell according to an embodiment.

### DETAILED DESCRIPTION

Hereinafter, the present disclosure will be described in detail with reference to the accompanying drawings.

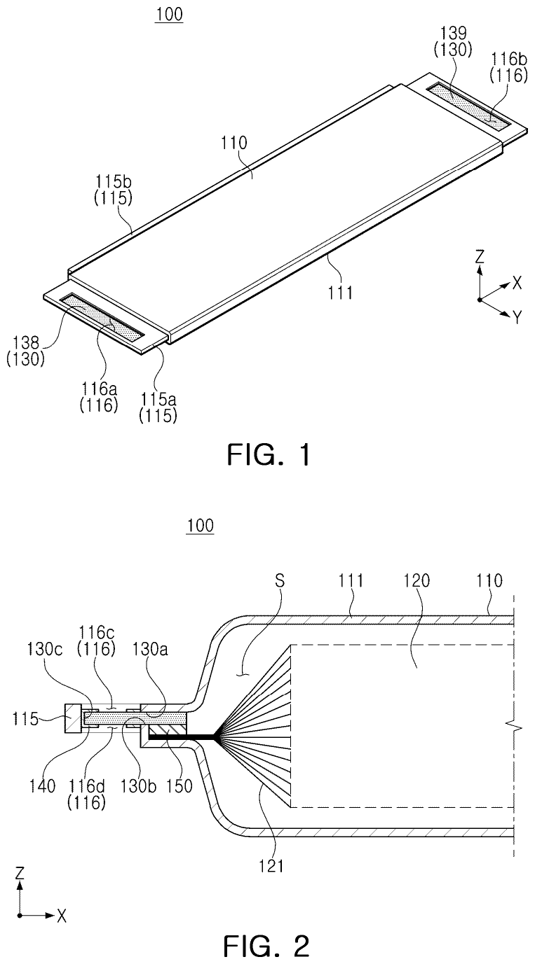

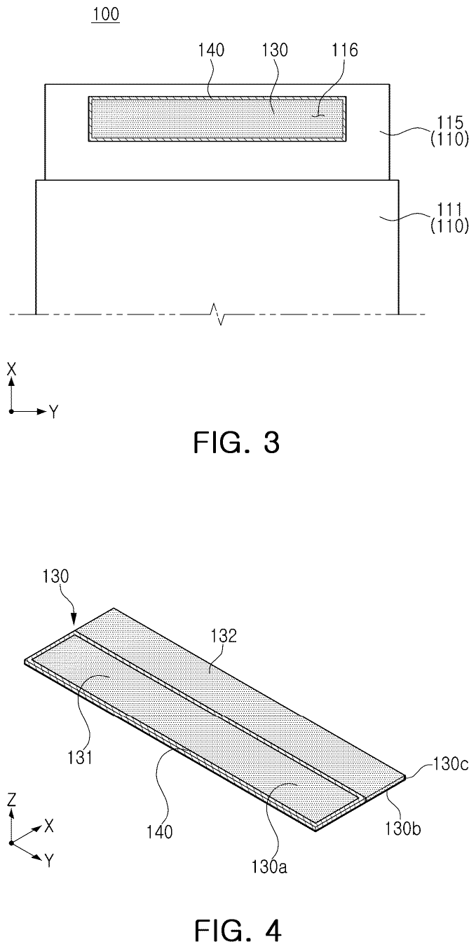

FIG. 1 is a perspective view of a battery cell according to an embodiment. FIG. 2 is a cross-sectional view of a battery cell according to an embodiment. FIG. 3 is a top view of a battery cell according to an embodiment. FIG. 4 is a perspective view of an electrode tab on which a sealant is disposed according to an embodiment.

Referring to FIGS. 1, 2, 3, and/or 4, a battery cell 100 may include a pouch 110, an electrode assembly 120, and an electrode tab 130.

The battery cell 100 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery that may be charged with and discharged of electricity.

The pouch 110 may form at least a portion of the exterior of the battery cell 100. The pouch 110 may include an electrode accommodating portion 111 accommodating the electrode assembly 120 and a sealing portion 115 surrounding at least a portion of the periphery of the electrode accommodating portion 111. The electrode accommodating portion 111 may provide an accommodating space S in which the electrode assembly 120 and an electrolyte are accommodated.

The sealing portion 115 may be formed by bonding at least a portion of the periphery of the pouch 110. The sealing portion 115 may be formed in a flange shape extending outwardly from the electrode accommodating portion 111 formed in a container shape and may be disposed along at least a portion of an outer edge of the electrode accommodating portion 111. In an embodiment, the sealing portion 115 may seal at least a portion of the electrode tab 130.

In an embodiment, the electrode tabs 130 may be disposed on both sides of the battery cell 100 in a length direction so as to face each other in opposite directions. For example, the electrode tab 130 may include a first electrode tab 138 facing one longitudinal side of the battery cell 100 and having a first polarity (e.g., a positive electrode) and a second electrode tab 139 facing the other longitudinal side of the battery cell 100 and having a second polarity (e.g., a negative electrode). The electrode tab 130 may be referred to as an electrode lead.

The direction in which the electrode tab 130 is located may be selectively designed. In an embodiment (e.g., FIG. 1), the electrode tab 130 may include a first electrode tab 130a and a second electrode tab 139 located in the opposite direction to the first electrode tab 138 with respect to the electrode assembly 120. In FIG. 1, the electrode tabs 130 are illustrated as being located in opposite directions on both longitudinal sides of the battery cell 100, but the structure of the electrode tabs 130 is not limited thereto. For example, the two electrode tabs 130 may be arranged to be substantially parallel in the length direction of the battery cell 100.

In an embodiment, the pouch 110 may have a structure in which a single sheet of outer casing is folded to form the sealing portion 115 on three sides. For example, in an embodiment of the present disclosure, at least a portion of the sealing portion 115 may be folded at least once to be formed. By folding at least a portion of the sealing portion 115, bonding reliability of the sealing portion 115 may be improved, and the area of the sealing portion 115 may be minimized. In an embodiment, the sealing portion 115 may include a first sealing portion 115a sealing the electrode tab 130 and a second sealing portion 115b extending from the first sealing portion 115a and not sealing the electrode tab 130. In an embodiment, at least a portion of the second sealing portion 115b may be fixed by an adhesive member (not illustrated) after being folded. The angle at which the second sealing portion 115b is bent or the number of times the second sealing portion 115b is bent may be selectively designed.

The electrode assembly 120 may include a cathode plate, an anode plate, and a separator. The separator may prevent contact between the cathode plate and the anode plate. Those skilled in the art will understand that the electrode assembly 120 may be manufactured using various methods. According to embodiments, a cathode, an anode, and the separator may be repeatedly arranged to form the electrode assembly. In some embodiments, the electrode assembly may be a winding-type, a stacking-type, a z-folding-type, or a stack-folding-type electrode assembly.

The electrode assembly 120 may include a current collector 121. In an embodiment, the current collector 121 may be a cathode current collector coated with a cathode active material of the cathode plate. The cathode current collector may include stainless steel, nickel, aluminum, titanium, or alloys thereof. The cathode current collector may include aluminum or stainless steel surface-treated with carbon, nickel, titanium, or silver. In an embodiment, the current collector 121 may be an anode current collector coated with an anode active material of the cathode plate. Non-limiting examples of the anode current collector may include copper foil, nickel foil, stainless steel foil, titanium foil, nickel foam, copper foam, polymer substrate coated with a conductive metal, etc.

The sealing portion 115 may accommodate the electrode tab 130. The electrode tab 130 may be located inside the pouch 110. At least a portion of the electrode tab 130 may be surrounded by the sealing portion 115. For example, the electrode tab 130 may be disposed within the sealing portion 115. For example, the electrode tab 130 may be disposed within the first sealing portion 115a. Since the electrode tab 130 is located inside the pouch 110, the energy density of the battery cell 100 may increase. The length (e.g., length in the X-axis direction) of the electrode tab 130 of the battery cell 100 of the present disclosure may be shorter than the length of the electrode tab 130 of the battery cell in which an end portion (e.g., a side surface 130c) of the electrode tab 130 protrudes outside the pouch 110. For example, the electrode tab 130 of the present disclosure may not extend or protrude outside the pouch 110. In contrast, in a battery cell (not illustrated) including an electrode tab protruding outside the pouch 110, the electrode tab may protrude outside the pouch 110 by a specified length (e.g., to 30 mm). The battery cell of the present disclosure may include the electrode assembly 120 having a length increased by the protrusion amount of the electrode tab. As the length of the electrode tab 130 decreases, the ratio of the electrode assembly 120 in the battery cell 100 may increase. As the size of the electrode assembly 120 increases, the energy density of the battery cell 100 may increase. The electrode tab 130 may be disposed or accommodated in the sealing portion 115.

The pouch 110 may include a through-hole 116 formed in the sealing portion 115. At least a portion of the electrode tab 130 may be exposed to the outside of the pouch 110 through the through-hole 116.

The electrode tab 130 may have a substantially rectangular parallelepiped shape. For example, the electrode tab 130 may include an upper surface 130a, a rear surface 130b opposite to the upper surface 130a, and a side surface 130c located between the upper surface 130a and the rear surface 130b. The side surface 130c may be covered by the pouch 110. The side surface 130c may be a surface surrounding at least a portion between the upper surface 130a and the rear surface 130b. For example, the side surface 130c may be a surface facing in the X-axis direction or the Y-axis direction of FIG. 4.

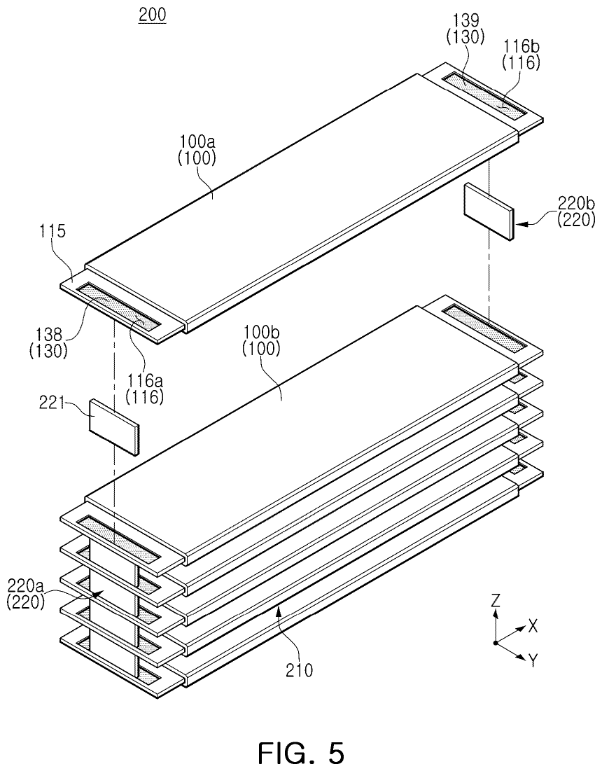

The through-hole 116 may penetrate through the pouch 110. For example, the through-hole 116 may be a hole penetrating through the pouch 110 in a thickness direction (a Z-axis direction). In an embodiment, the through-hole 116 may include a first recess 116c facing the upper surface 130a and a second recess 116d facing the rear surface 130b. The electrode tab 130 may be electrically connected to the exterior of the pouch 110 (e.g., the busbar 220 of FIG. 5) through the recesses 116c and 116d. The recesses 116c and 116d may be empty spaces formed in the pouch 110. For example, the first recess 116c may be a through-hole formed in an upper portion of the pouch 110, and the second recess 116d may be a through-hole formed in the lower portion of the pouch 110.

The electrode tab 130 may be electrically connected to the electrode assembly 120. The electrode tab 130 may provide a path for transmitting the current of the electrode assembly 120 to the outside of the battery cell 100. For example, the electrode tab 130 may include a first region 131 located between the first recess 116c and the second recess 116d and at least partially exposed to the outside of the through-hole 116 and a second region 132 extending from the first region 131 and bonded to the current collector 121 of the electrode assembly 120. For example, the second region 132 of the electrode tab 130 may be connected to the current collector 121 through a bonding portion 150. The bonding portion 150 may be a molten portion of the current collector 121 and the electrode tab 130 formed during a welding process of the electrode tab 130 and the current collector 121.

The battery cell 100 may include a sealant 140. The sealant 140 may seal a gap between the electrode tab 130 and the sealing portion 115. For example, the sealant 140 may prevent leakage of the electrolyte of the battery cell 100 through an empty space between the through-hole 116 of the sealing portion 115 and the electrode tab 130. The sealant 140 may prevent foreign substances from being introduced from the outside of the battery cell 100 to the inside of the battery cell 100 (e.g., the accommodating space S). In an embodiment, the sealant 140 may be formed in a closed curve shape.

The sealant 140 may be located between the electrode tab 130 and the pouch 110. For example, the sealant 140 may cover a portion of the first region 131 of the electrode tab 130. In an embodiment, another portion of the first region 131 not covered by the sealant 140 may be exposed to the outside of the battery cell 100 through the through-hole 116. In an embodiment, the sealant 140 may cover at least a portion of the upper surface 130a of the electrode tab 130, at least a portion of the rear surface 130b of the electrode tab 130, and at least a portion of the side surface 130c of the electrode tab 130. In an embodiment, the sealant 140 may be fused to the electrode tab 130 and coupled to the electrode tab 130.

The sealant 140 may be formed of a material for bonding with the pouch 110. For example, the sealant 140 may be a resin having heat-melting properties. In an embodiment, the sealant 140 may include polypropylene and/or polyethylene.

FIG. 5 is a perspective view of a battery module according to an embodiment.

Referring to FIG. 5, together with FIGS. 1 to 4, a battery module 200 may include a cell assembly 101 including a plurality of battery cells 100 and a busbar 220.

The cell assembly 101 may include a plurality of battery cells 100 stacked in the thickness direction (the Z-axis direction) of the battery cell 100. The description of the battery cell 100 of FIGS. 1 to 4 may be applied to the battery cell 100 of FIG. 5. The plurality of battery cells 100 may be connected to each other using a connecting tape (not illustrated).

The busbar 220 may electrically connect the plurality of battery cells 100. For example, the busbar 220 may be bonded or connected to the electrode tab 130. The busbar 220 may be connected to an external conductor and may transmit the current of the cell assembly 101 to the outside of the battery module 200. The busbar 220 may be provided in plural. For example, the busbar 220 may include a first busbar 220a connected to a first electrode tab 138 and a second busbar 220b connected to a second electrode tab 139.

The busbar 220 may include a plurality of conductive blocks 221 respectively located between the electrode tabs 130 of the plurality of battery cells 100. For example, the plurality of battery cells 100 may include a first battery cell 100a and a second battery cell 100b adjacent to the first battery cell 100a. The conductive block 221 may be located between the electrode tab 130 of the first battery cell 100a and the electrode tab 130 of the second battery cell 100b.

Referring to FIG. 2, together with FIG. 5, the electrode tab 130 may include the upper surface 130a, a rear surface 130b opposite to the upper surface 130a, and the side surface 130c located between the upper surface 130a and the rear surface 130b. The side surface 130c is covered by the pouch 110. The upper surface 130a and the rear surface 130b may be in contact with a plurality of conductive blocks 221.

The through-hole 116 may accommodate at least a portion of the conductive block 221. In an embodiment, the conductive block 221 may be in contact with the rear surface 130b of the electrode tab 130 of the first battery cell 100a and the upper surface 130a of the electrode tab 130 of the second battery cell 100b. At least a portion of the conductive block 221 may be inserted into the through-hole 116. For example, the through-hole 116 may include the first recess 116c facing the upper surface 130a and the second recess 116d facing the rear surface 130b. Each of the conductive blocks 221 has at least a portion located within the first recess 116c and the second recess 116d. By positioning the conductive block 221 between the electrode tabs 130, dead space of the battery module 200 may be reduced, and the energy density of the battery module 200 may increase. By using the conductive block 221, the total weight of the busbar 220 and the production cost of the busbar 220 may be reduced.

The battery module 200 may include a module housing (not illustrated) accommodating a cell assembly 210 and a busbar 220. The shape of the module housing may be selectively designed.

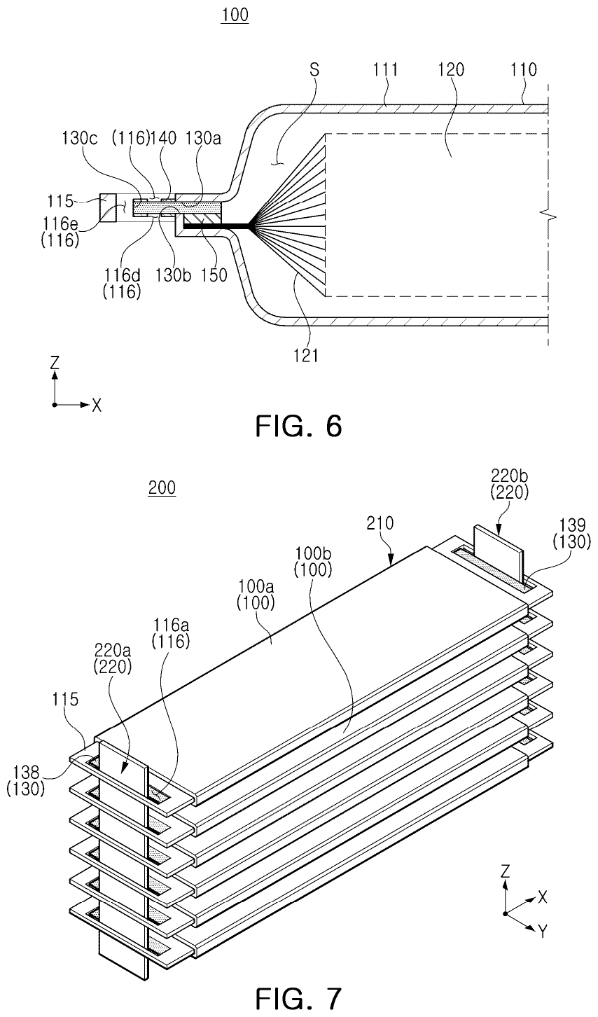

FIG. 6 is a perspective view of a battery cell according to another embodiment. FIG. 7 is a perspective view of a battery module according to another embodiment.

Referring to FIGS. 6 and 7, the battery cell 100 may include the pouch 110, the electrode assembly 120, the electrode tab 130, the sealant 140, and the bonding portion 150. The battery module 200 may include the cell assembly 210 including a plurality of battery cells 100 and the busbar 220. At least a portion of the description of the battery cell 100, the pouch 110, the electrode assembly 120, the electrode tab 130, the sealant 140, the bonding portion 150, the battery module 200, the cell assembly 210, and/or the busbar 220 of FIGS. 1 to 5 may be applied to the battery cell 100, the pouch 110, the electrode assembly, 120, the electrode tab 130, the sealant 140, the bonding portion 150, the battery module 200, the cell assembly 210, and/or the busbar 220 of FIGS. 6 and 7.

The pouch 110 may include the through-hole 116 formed in the sealing portion 115. At least a portion of the electrode tab 130 may be exposed to the outside of the pouch 110 through the through-hole 116. The through-hole 116 may penetrate through the pouch 110. For example, the through-hole 116 may be a hole penetrating through the pouch 110 in the thickness direction (the Z-axis direction). In an embodiment, the electrode tab 130 may include the upper surface 130a, the rear surface 130b opposite to the upper surface 130a, and the side surface 130c located between the upper surface 130a and the rear surface 130b. The through-hole 116 may include the third recess 116e facing at least a portion of the side surface 130c. For example, the third recess 116e may penetrate through upper and lower portions of the sealing portion 115. The third recess 116e may accommodate a busbar (e.g., the busbar 220 of FIG. 7). In an embodiment, the through-hole 116 may include the first recess 116c facing the upper surface 130a together with the third recess 116e and/or the second recess 116d facing the rear surface 130b. In an embodiment (not illustrated), the through-hole 116 may include the third recess 116e and may not include the first recess 116c and the second recess 116d. For example, the side surface 130c of the electrode tab 130 may be exposed to the outside of the pouch 110 through the third recess 116e, and the front surface 130a and the rear surface 130b of the electrode tab 130 may be covered by the pouch 110.

The electrode tab 130 may be electrically connected to the outside of the pouch 110 (e.g., the busbar 220 of FIG. 5 or 7) through the through-hole 116. At least a portion of the electrode tab 130 may be located within the through-hole 116. The through-hole 116 may accommodate the busbar 220 together with the electrode tab 130.

The busbar 220 may electrically connect the plurality of battery cells 100. For example, the busbar 220 may be bonded or connected to the electrode tab 130. The busbar 220 may be connected to an external conductor to transmit the current of the cell assembly 101 to the outside of the battery module 200. The busbar 220 may be provided in plural. For example, the busbar 220 may include a first busbar 220a connected to the first electrode tab 138 and a second busbar 220b connected to the second electrode tab 139.

The busbar 220 may have a bar or plate shape contacting the plurality of battery cells 100. For example, in an embodiment, the busbar 220 may pass through the third recesses 116e of the plurality of battery cells 100 and electrically connect the electrode tabs 130 of the plurality of battery cells 100. The first busbar 220a and the second busbar 220b may be inserted into the through-holes 116 of the plurality of battery cells 100, respectively. The first busbar 220a and the second busbar 220b may pass through the third recesses 116e of the plurality of battery cells 100, respectively, and be electrically connected to the electrode tabs 130. For example, the busbar 220 may be in contact with the side surface 130c of the electrode tabs 130. The third recess 116e may accommodate at least a portion of the busbar 220. In an embodiment (not illustrated), the sealant 140 may cover at least a portion of the upper surface 130a of the electrode tab 130 and at least a portion of the rear surface 130b of the electrode tab 130.

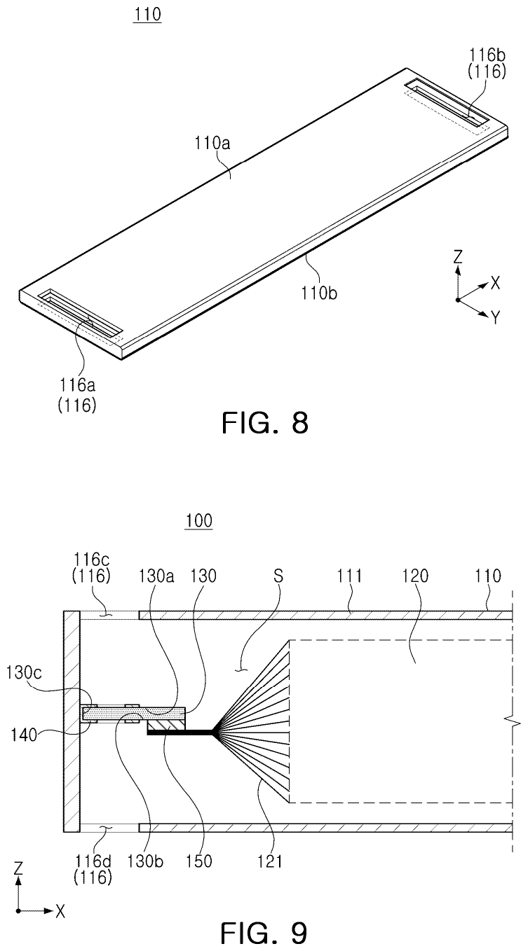

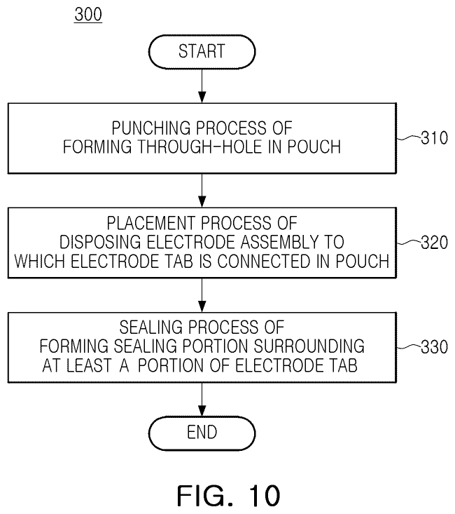

FIGS. 8 and 9 are diagrams illustrating a method of manufacturing a battery cell according to an embodiment. FIG. 10 is a flowchart of a method of manufacturing a battery cell according to an embodiment.

Referring to FIGS. 8, 9, and/or 10 along with FIG. 2, a battery cell manufacturing method 300 may include a punching process 310 of forming a through-hole in a pouch, a placement process 320 of disposing an electrode assembly to which an electrode tab is connected in the pouch, and a sealing process 330 of forming a sealing portion surrounding at least a portion of the electrode tab. The battery cell manufacturing method 300 of FIG. 10 may be a method of manufacturing the battery cell 100 of FIGS. 1, 2, 3, 5, 6, and/or 7.

Referring to FIGS. 8 and 10, the punching process 310 may be a process of forming the through-hole 116 in the pouch 110. The punching process 310 may be a process of forming the through-hole 116 by removing a portion of the pouch 110 using a laser and/or a tool. For example, the punching process 310 may be a process of forming the through-hole 116 penetrating through a first surface 110a (e.g., an upper surface) and a second surface 110b (e.g., a lower surface) of the pouch 110. For example, through the punching process 310, the first through-hole 116a and the second through-hole 116b located to be adjacent to both end portions of the pouch 110 may be formed. Since the punching process 310 is performed before the placement process 320, damage to the electrode tab 130 may be prevented. In an embodiment, the punching process 310 may be performed by a different entity from the placement process 320 and the sealing process 330. For example, the punching process 310 may be replaced with a preparation process of preparing the pouch 110 in which the through-hole 116 is formed.

Referring to FIGS. 9 and 10, the placement process 320 may be a process of disposing the electrode assembly 120 connected to the electrode tab 130 in the pouch 110. For example, the placement process 320 may be a process of inserting the electrode assembly 120 into the accommodating space S of the pouch 110 using a jig and/or a robot. The placement process 320 may be a process of adjusting the position of the electrode assembly 120 so that the electrode tab 130 faces the through-hole 116 of the pouch 110.

The electrode tab 130 may include the upper surface 130a, the rear surface 130b opposite to the upper surface 130a, and the side surface 130c located between the upper surface 130a and the rear surface 130b. In an embodiment, the placement process 320 may be a process of allowing the upper surface 130a to face the first recess 136c of the through-hole 136 and allowing the rear surface 130b to face the second recess 136d of the through-hole 136. In another embodiment, the placement process 320 may be a process of allowing the side surface 130c to face the third recess (e.g., the third recess 116e of FIG. 6) of the through-hole 136.

For convenience of description, a portion (e.g., the second sealing portion 115b and a gas chamber) of the pouch 110 is omitted. For example, in the placement process 320, the electrode assembly 120 may be disposed in the pouch 110 through an empty space before the second sealing portion 115b is sealed.

Referring to FIGS. 2 and 10, the sealing process 330 may be a process of forming the sealing portion 115 surrounding at least a portion of the electrode tab 130. For example, the sealing process 330 may be a process of heating and/or pressing a portion of the pouch 110 using a sealing tool (e.g., a sealing bar or a sealing block). During the sealing process 330, the pouch 110 may be pressed so that the sealing portion covers at least a portion of the electrode tab 130 while at least a portion of the electrode tab 130 faces the through-hole 116. During the sealing process 330, sealing is performed in a state in which the electrode tab 130 is located inside the pouch 110 and at least a portion of the electrode tab 130 is exposed (e.g., visually exposed) to the outside of the pouch 110 through the through-hole 116.

According to an embodiment of the present disclosure, the energy density of the battery cell may be increased.

According to an embodiment of the present disclosure, dead space of the battery cell or a battery module may be reduced.

Only specific examples of implementations of certain embodiments are described. Variations, improvements and enhancements of the disclosed embodiments and other embodiments may be made based on the disclosure of this patent document.

What is claimed is:

1. A battery cell comprising:
an electrode assembly;
a pouch including an electrode accommodating portion accommodating the electrode assembly and a sealing portion surrounding at least a portion of the electrode accommodating portion; and
an electrode tab electrically connected to the electrode assembly and located inside the pouch,
wherein the pouch includes a through-hole formed in the sealing portion, and the electrode tab is exposed to the outside of the pouch through the through-hole.

2. The battery cell of claim 1, wherein the electrode tab is disposed within the sealing portion.

3. The battery cell of claim 1, wherein the electrode tab includes an upper surface, a rear surface opposite to the upper surface, and a side surface located between the upper surface and the rear surface, and the side surface is covered by the pouch.

4. The battery cell of claim 3, wherein the through-hole includes a first recess facing the upper surface and a second recess facing the rear surface.

5. The battery cell of claim 4, wherein the electrode tab includes a first region located between the first recess and the second recess and at least partially exposed to the outside of the through-hole and a second region extending from the first region and bonded to a current collector of the electrode assembly.

6. The battery cell of claim 1, wherein the electrode tab includes an upper surface, a rear surface opposite to the upper surface, and a side surface located between the upper surface and the rear surface, and the through-hole includes a third recess facing at least a portion of the side surface and penetrating through upper and lower portions of the sealing portion.

7. The battery cell of claim 1, further comprising a sealant sealing a gap between the electrode tab and the sealing portion.

8. A battery module comprising:
a cell assembly including a plurality of battery cells; and
a busbar electrically connecting the plurality of battery cells,
wherein the plurality of battery cells respectively include:
an electrode assembly;
a pouch including an electrode accommodating portion accommodating the electrode assembly and a sealing portion surrounding at least a portion of the electrode accommodating portion; and
an electrode tab electrically connected to the electrode assembly and located inside the pouch,
wherein the pouch includes a through-hole formed in the sealing portion, and the electrode tab is exposed to the outside of the pouch through the through-hole.

9. The battery module of claim 8, wherein the busbar includes a plurality of conductive blocks respectively located between the electrode tabs of the plurality of battery cells.

10. The battery module of claim 9, wherein the electrode tab includes an upper surface, a rear surface opposite to the upper surface, and a side surface located between the upper surface and the rear surface, the side surface is covered by the pouch, and the upper surface and the rear surface are in contact with the plurality of conductive blocks.

11. The battery module of claim 10, wherein the through-hole includes a first recess facing the upper surface and a second recess facing the rear surface, and each of the plurality of conductive blocks has at least a portion located within the first recess and the second recess.

12. The battery module of claim 8, wherein
the electrode tab includes an upper surface, a rear surface opposite to the upper surface, and a side surface located between the upper surface and the rear surface,
the through-hole includes a third recess facing at least a portion of the side surface and penetrating through upper and lower portions of the sealing portion, and
the busbar passes through the third recess of the plurality of battery cells and electrically connects the electrode tabs of the plurality of battery cells.

13. A method of manufacturing a battery cell, the method comprising:
a punching process of forming a through-hole in a pouch;
a placement process of disposing an electrode assembly to which an electrode tab is connected in the pouch so that at least a portion of the electrode tab faces the through-hole; and
a sealing process of forming a sealing portion surrounding at least a portion of the electrode tab.

14. The method of claim 13, wherein the sealing process is a process of pressing the pouch so that the sealing portion covers at least a portion of the electrode tab while at least a portion of the electrode tab faces the through-hole.

15. The method of claim 13, wherein the electrode tab includes an upper surface, a rear surface opposite to the upper surface, and a side surface located between the upper surface and the rear surface, and the placement process is a process of allowing the upper surface to face a first recess of the through-hole and the rear surface to face a second recess of the through-hole.
